(19) United States
(12) Patent Application Publication
(10) Pub. No.: US 2025/0055532 A1
(43) Pub. Date: Feb. 13, 2025

(54) NETWORK NODE, USER EQUIPMENT AND METHODS FOR CSI-RS CONFIGURATION

(71) Applicant: Telefonaktiebolaget LM Ericsson (publ), Stockholm (SE)

(72) Inventors: Yufeng ZHAO, UPPLANDS VÄSBY (SE); Mikael WITTBERG, VISBY (SE)

(73) Assignee: Telefonaktiebolaget LM Ericsson (publ), Stockholm (SE)

(21) Appl. No.: 18/722,723

(22) PCT Filed: Dec. 23, 2021
(86) PCT No.: PCT/SE2021/051312

§ 371 Date: Jun. 21, 2024

(51) Int. Cl. H04B 7/06; H04W 24/10

(52) U.S. Cl. CPC H04B 7/0626; H04W 24/10

(57) ABSTRACT

A network node (150) comprising TRPs and a method for configuring CSI-RS reporting for a UE (100). The method comprises sending (102) at least a first and a second set of CSI-RSs. The first set is sent as a joint transmission from a group of TRPs and the second set is TRP-specific among said group. The method comprises receiving (103) a UE capability information; sending a configuration message to the UE for the UE to become configured to report on at least one CSI-RS from at least one of the first and second set based on the UE capability information; and sending an indication to the UE indicating which of the configured at least one CSI-RS the UE shall measure and report on. A UE, a method performed by a UE, corresponding computer programs and computer program products are disclosed.

### TECHNICAL FIELD

Embodiments presented herein relate to a method performed by a network node comprising transmission reception points in a cellular communication network for configuring Channel State Information Reference Signal (CSI-RS) reporting fora User Equipment (UE); a method performed by a UE; corresponding computer programs and computer program products; a network node and a UE.

### BACKGROUND

In a cellular communication network, there is a need to measure the channel conditions to determine what transmission parameters to use. This is done for both downlink (DL) communication from a network node to a UE, and uplink (UL) communication from the UE to the network node. The four main reference signals used in a 3rd Generation Partnership Project (3GPP) 5th Generation (5G) cellular networks with New Radio (NR) access networks to support good channel conditions are a Demodulation Reference Signal (DMRS), a Phase Tracking Reference Signal (PTRS), a Sounding Tracking Reference Signal (SRS) and a CSI-RS.

The CSI-RS is a DL signal which enables the UE to estimate the channel and then report channel quality information back to the network node in a CSI-RS report. Furthermore, CSI-RS may be divided into non-zero power (NZP) CSI-RS and zero power (ZP) CSI-RS, wherein ZP CSI-RS also is known as channel state information interference measurement (CSI-IM). The periodicity of CSI-RS may be configured to be periodic, semi-persistent or aperiodic.

In an example, a cell in a telecommunication network comprises a network node, e.g., base station, and one or more transmission reception points for wireless communication with UEs in the cell, typically denoted multiple transmission and reception point (multi-TRP) cell. There are several ways to deploy a multi-TRP cell in terms of mobility and communication between UE and TRP. Dynamic Point Switching, DPS, and Single Frequency Network, SFN, are two of the most common methods. With DPS a UE is switched to be served by the best TRP, in terms of e.g. signal quality, upon moving within the multi-TRP cell and air interface resources can be re-used per TRP. An SFN based method provides seamless mobility in that multiple TRPs send and/or receive signals to/from the UE as a group. However, air interface resources cannot be efficiently re-used between the TRPs since channel estimation for link adaptation per TRP would be less accurate.

There are several configurations for transmitting a CSI-RS to a UE. One configuration is to transmit a CSI-RS from a group of TRPs in the multi-TRP cell, also called joint transmission. This allows for a UE to measure and report on a CSI-RS independently of which TRP the UE is served by. This configuration may be especially useful when several TRPs are serving the UE.

Another configuration allows a UE to measure and report on a CSI-RS from the TRP it is currently served by or the TRP it is chosen to measure and report on. In TRP-specific CSI-RS reporting a UE needs to change which CSI-RS to report on upon change of serving TRP. The reconfiguration of a CSI-RS may be done by a layer 3 protocol radio resource control (RRC). The UE can also be configured with a list of CSI-RSs and use a layer 2 protocol medium access control (MAC) to switch the active CSI-RS, where MAC signaling is preferred with regards to e.g. latency and network performance. However, there is a capability requirement on the UE to support multiple CSI-RS resources in order to benefit from MAC signaling, since it prior to changing TRP from a first TRP to a second TRP must be configured with the CSI-RS of the second TRP.

Coordinated multipoint (CoMP) refers to a wide range of different techniques but generally describes a scenario where a user and control plane data may be shared between base stations and/or TRPs in order to coordinate DL and UL transmissions. One such coordination may for example be two TRPs serving a UE, e.g. transmitting the same data to a UE, alternatively each TRP transmitting parts of the downlink data to the UE.

Joint transmission of CSI-RS has the advantage of seamless mobility within a multi-TRP cell, meaning there may be no need for any reconfiguration or switch of a CSI-RS whilst the UE is moving within the multi-TRP cell. Furthermore, the UE experiences increased coverage since the same data may be transmitted from multiple TRPs in the multi-TRP cell. See WO 2015/116619 A1 for further information about CSI-RS, joint transmission, CoMP and DPS in Long Term Evolution (LTE).

Both jointly transmitted and TRP specific CSI-RS merit advantages and disadvantages in comparison to one another. A solution which effectively utilizes both modes is desired for further improvement of cellular communication technology and in particular NR-technology.

### SUMMARY

An object of the invention is to enable improvement of network performance with respect to reducing latency, decreasing interference, and/or with respect to efficient use of radio resources, e.g. physical resource blocks, through flexible configuration of CSI-RS signaling. This and other objects are met by means of different aspects of the invention, as defined by the claims appended hereto.

According to a first aspect, a method, performed by a network node which comprises TRPs, is provided for configuring CSI-RS reporting for a UE in a cellular communication network. The method comprises: sending at least a first and a second set of CSI-RSs, wherein the first set is sent as a joint transmission from a group of TRPs and the second set is TRP-specific among said group; receiving a UE capability information, wherein the UE capability information indicates a maximum number of CSI-RS resources the UE can be configured to report on; sending a configuration message to the UE for the UE to become configured to report on at least one CSI-RS from at least one of the first and second set based on the UE capability information; and sending an indication to the UE indicating which of the configured at least one CSI-RS the UE shall measure and report on.

According to an embodiment of the first aspect, the method further comprises: sending a further configuration message to the UE for the UE to become re-configured to report on at least a chosen TRP's CSI-RS from the second set if not already configured with said CSI-RS. The indication indicates to the UE to report on said chosen TRP's CSI-RS from the second set if the maximum number of CSI-RS resources the UE can be configured to report on is below a first threshold value and a data traffic of the UE is below a second threshold.

According to a second aspect, a method performed by a UE is provided for becoming configured for CSI-RS reporting. The method comprises: sending a UE capability information to a network node, wherein the UE capability information indicates a maximum number of CSI-RS resources the UE can be configured to report on; receiving a configuration message for the UE to become configured to report on at least one CSI-RS from at least one of a first and second set of CSI-RSs based on the UE capability information, wherein the first set is sent as a joint transmission from a group of TRPs comprised by the network node and the second set is TRP-specific among said group; and receiving an indication indicating which of the configured at least one CSI-RS the UE shall measure and report on.

According to an embodiment of the first aspect or the second aspect, the configuration message enables the UE to become configured to report on at least a CSI-RS from the first set if the maximum number of CSI-RS resources the UE can be configured to report on is below a first threshold value.

According to an embodiment of the first aspect or the second aspect, the configuration message enables the UE to become configured to report on at least a group of CSI-RSs from the second set if the maximum number of CSI-RS resources the UE can be configured to report on is equal to or above a first threshold value.

According to an embodiment of the first aspect or the second aspect, the configuration message further enables the UE to become configured to report on at least a CSI-RS from the first set.

According to an embodiment of the first aspect or the second aspect, the indication indicates to the UE to measure and report on a CSI-RS from the first set if the maximum number of CSI-RS resources the UE can be configured to report on is below a first threshold value.

According to an embodiment of the first aspect or the second aspect, the indication indicates to the UE to measure and report on a chosen TRP's CSI-RS from the second set if the maximum number of CSI-RS resources the UE can be configured to report on is equal to or above a first threshold value.

According to an embodiment of the first aspect or the second aspect, the first threshold value is four.

According to an embodiment of the first aspect or the second aspect, the indication is based on a traffic scenario. The traffic scenario corresponds to at least one of: a data traffic of the UE; and whether coordinated multipoint (CoMP) signaling is desired.

According to an embodiment of the first aspect or the second aspect, the data traffic is associated with at least one of a QoS parameter, a QoS identifier (5QI) and a mobility indication for the UE. The indication is based on at least one of: the at least one QoS parameter and/or 5QI value being equal to or above a second threshold value; the at least one QoS parameter and/or 5QI value being included in, or excluded from, a threshold list comprising at least one of a QoS parameter and a 5QI value; and whether the UE is stationary or not, based on a past and/or future change in position.

According to an embodiment of the first aspect or the second aspect, the indication indicates to the UE to report on a CSI-RS from the first set if the maximum number of CSI-RS resources the UE can be configured to report on is below a first threshold value and a data traffic of the UE is equal to or above a second threshold.

According to an embodiment of the second aspect, the method further comprises: receiving a further configuration message for enabling the UE to become re-configured to report on at least a chosen TRP's CSI-RS from the second set if not already configured with said CSI-RS. The indication indicates to the UE to report on said chosen TRP's CSI-RS from the second set if the maximum number of CSI-RS resources the UE can be configured to report on is below a first threshold value and a data traffic of the UE is below a second threshold.

According to an embodiment of the first aspect or the second aspect, the indication indicates to the UE to report on a CSI-RS from the first set if the number of CSI-RS resources the UE supports is above a first threshold value and CoMP signaling is desired.

According to an embodiment of the first aspect or the second aspect, the indication indicates to the UE to report on a chosen TRP's CSI-RS from the second set if the number of CSI-RS resources the UE supports is above a first threshold value and CoMP signaling is not desired.

According to an embodiment of the first aspect or the second aspect, the indication is comprised in the configuration message or is the configuration message.

According to an embodiment of the first aspect or the second aspect, the UE capability information is comprised in UECapabilitylnformation.

According to an embodiment of the first aspect or the second aspect, the maximum number of CSI-RS resources the UE can be configured to report on is indicated by the minimum value of the parameters: maxConfigNumberNZP-CSI-RS-PerCC, and maxNumberAperiodicCSI-PerBWP-ForCSI-Report. The parameters maxConfigNumberNZP-CSI-RS-PerCC and maxNumberAperiodicCSI-PerBWP-ForCSI-Report are comprised in the UE capability information.

According to an embodiment of the first aspect or the second aspect, the configuration message is comprised in at least one of RRCReconfiguration or RRCConnectionReconfiguration in 5G and 4G correspondingly.

According to an embodiment of the first aspect or the second aspect, the indication indicating which of the configured at least one CSI-RS the UE shall measure and report on is a trigger.

According to an embodiment of the first aspect or the second aspect, the indication indicating which of the configured at least one CSI-RS the UE shall measure and report on is comprised in at least one of SP CSI-RS/CSI-IM Resource SetActivation/Deactivation MAC CE and downlink control information.

According to an embodiment of the first aspect or the second aspect, the first threshold is based on at least one of: a number of TRPs in a multi-TRP cell, a number of component carriers assigned to the UE, a carrier aggregation requirement, a minimal re-use ratio of CSI-RSs in a multi-TRP cell and a reference UE model.

According to a third aspect, a network node comprising TRPs is provided for configuring CSI-RS reporting for a UE in a cellular communication network. The network node comprises processing circuitry and a memory comprising computer readable instructions executable by the processing circuitry, whereby the network node is configured to: send at least a first and a second set of CSI-RSs, wherein the first set is sent as a joint transmission from a group of TRPs and the second set is TRP-specific among said group; receive a UE capability information, wherein the UE capability information indicates a maximum number of CSI-RS resources a UE can be configured to report on; send a configuration message to the UE for the UE to become configured to report on at least one CSI-RS from at least one of the first and second set based on the UE capability information; and send an indication to the UE indicating which of the configured at least one CSI-RS the UE shall measure and report on.

According to an embodiment of the third aspect, the network node comprising TRPs is further configured to perform the method according to any of the embodiments of the first aspect.

According to a fourth aspect, a UE is provided. The UE comprises processing circuitry and a memory comprising computer readable instructions executable by the processing circuitry, whereby the UE is configured to: send a UE capability information to a network node, wherein the UE capability information indicates a maximum number of CSI-RS resources the UE can be configured to report on; receive a configuration message for the UE to become configured to report on at least one CSI-RS from at least one of a first and second set of CSI-RSs based on the UE capability information, wherein the first set is sent as a joint transmission from a group of TRPs comprised by the network node and the second set is TRP-specific among said group; and receive an indication indicating which of the configured at least one CSI-RS the UE shall measure and report on.

According to an embodiment of the fourth aspect, the UE is configured to perform the method according to any of the embodiments of the second aspect.

According to a fifth aspect, a computer program is provided. The computer program comprises computer readable instructions which, when executed on processing circuitry in a network node comprising TRPs, cause the network node to carry out the method according to any of the embodiments of the first aspect.

According to a sixth aspect, a computer program is provided. The computer program comprises computer readable instructions which, when executed on processing circuitry in a UE, cause the UE to carry out the method according to any of the embodiments of the second aspect.

According to a seventh aspect, a computer program product is provided. The computer program product comprises a computer-readable storage medium having a computer program according to the fifth aspect stored thereon.

According to an eighth aspect, a computer program product is provided. The computer program product comprises a computer-readable storage medium having a computer program according to the sixth aspect stored thereon.

By the aspects provided above is achieved that a UE can become configured with and measure and report on a CSI-RS based on a capability of the UE, wherein the capability is the maximum number of CSI-RS resources the UE can be configured to report on. In comparison to only using TRP-specific CSI-RS signaling in a multi-TRP cell, the need for RRC-reconfiguration is decreased by applying joint transmission of CSI-RSs for some UEs, based on each UE's capability, allowing for reduced latency and interference. In comparison to only using joint transmission of CSI-RSs in a multi-TRP cell, it is possible to re-use radio resources, e.g. PRBs, between the TRPs of the multi-TRP cell since TRP-specific CSI-RSs are applied to some UEs, based on each UE's capability.

### BRIEF DESCRIPTION OF THE DRAWINGS

The accompanying drawings, which are incorporated herein and form part of the specification, illustrate various embodiments.

FIG. 1 is a flowchart illustrating embodiments of a method performed by a network node in relation to configuration of CSI-RS reporting for a UE.

FIG. 2 is a flowchart illustrating a process for configuration of CSI-RS reporting according to an embodiment, wherein the configuration is based on a UE capability.

FIG. 3 illustrates CSI-RS reporting configurations and multi-TRP-cell mobility scenarios according to an embodiment, wherein the configuration is based on a UE capability.

FIG. 4 is a flowchart illustrating a process for configuration of CSI-RS reporting according to an embodiment, wherein CSI-RS reporting configuration is based on a data traffic of a low capability UE.

FIG. 5 is a flowchart illustrating a process for configuration of CSI-RS reporting according to an embodiment, wherein CSI-RS reporting configuration is based on a data traffic of a high capability UE.

FIG. 6 illustrates CSI-RS reporting configurations and multi-TRP-cell mobility scenarios according to an embodiment, wherein the configuration is based on a UE capability and a data traffic of a UE.

FIG. 7 is a flowchart illustrating embodiments of a method performed by a UE in relation to configuration of CSI-RS reporting for a UE.

FIG. 8 illustrates a network node according to some embodiments.

FIG. 9 illustrates a user equipment according to some embodiments.

### DETAILED DESCRIPTION

The invention will now be described more fully herein with reference to the accompanying drawings, in which certain embodiments of the invention are shown. This invention may, however, be embodied in many different forms and should not be construed as limited to the embodiments set forth herein. Rather, these embodiments are provided by way of example so that this disclosure will be thorough and complete, and will fully convey the scope of the invention to those skilled in the art.

Embodiments of the invention relate to a network node 150 comprising multiple TRPs, 20, also referred to as multi-TRP cell 19 however, the invention may be embodied in many different forms and the term multi-TRP cell should not be construed as limiting to the scope of the disclosure. In an embodiment, a multi-TRP cell is interpreted as a group of TRPs, wherein a group refers to at least two TRPs. Said group of TRPs can be co-sited or spread out in a cell coverage area of the multi-TRP cell. Said TRPs in the group may each have the capabilities of a base station, e.g. an eNB or a gNB. Furthermore, a TRP 20 is defined as: antenna array with one or more antenna elements available to the network located at a specific geographical location for a specific area. Throughout the disclosure, when a network node sends/receives a message, it is to be read as the network node itself, e.g. base station, and/or any of the TRPs in the multi-TRP cell sends/receives the message.

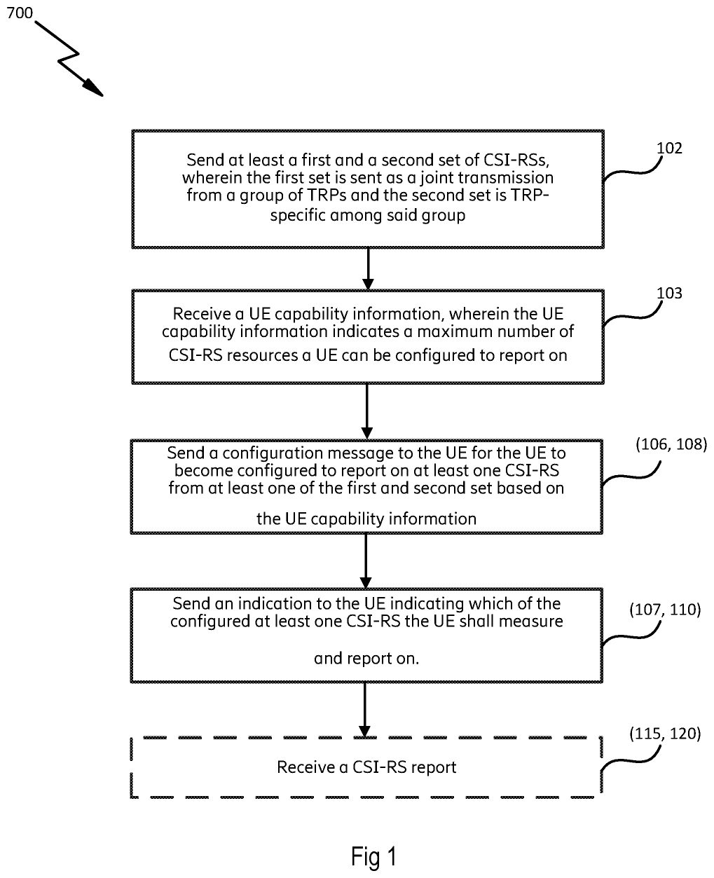

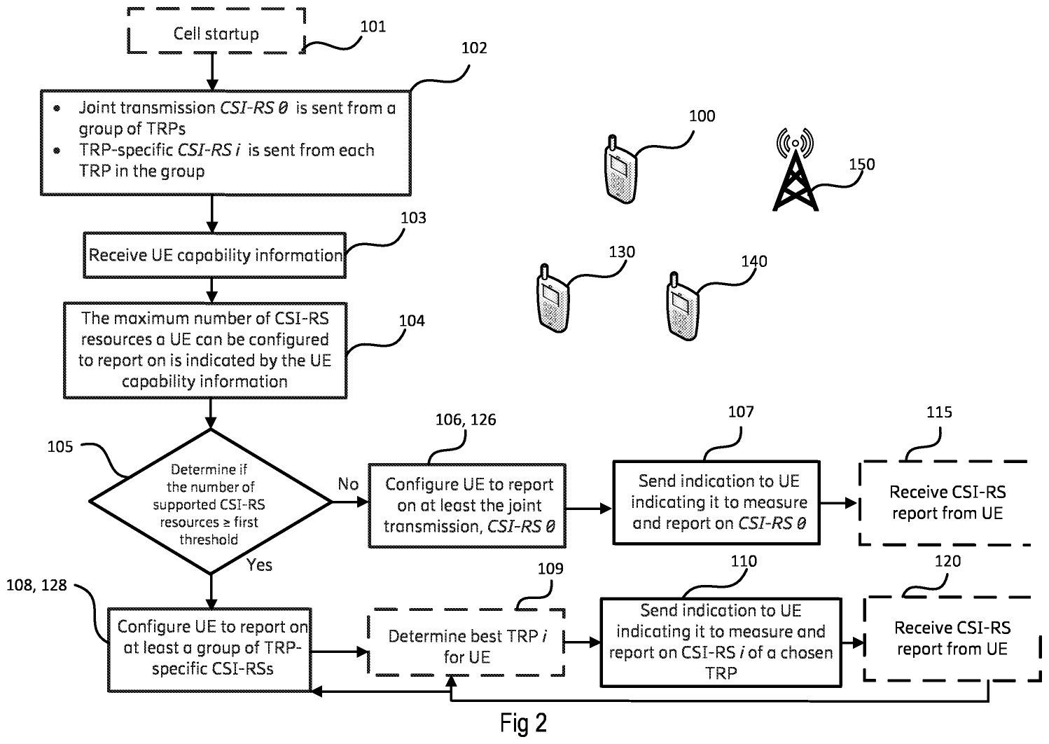

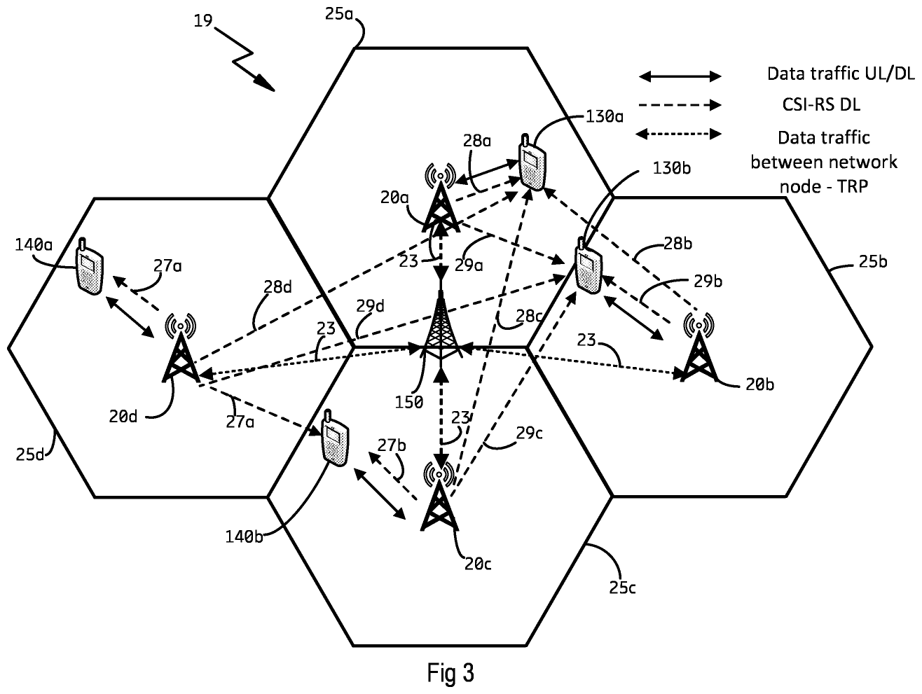

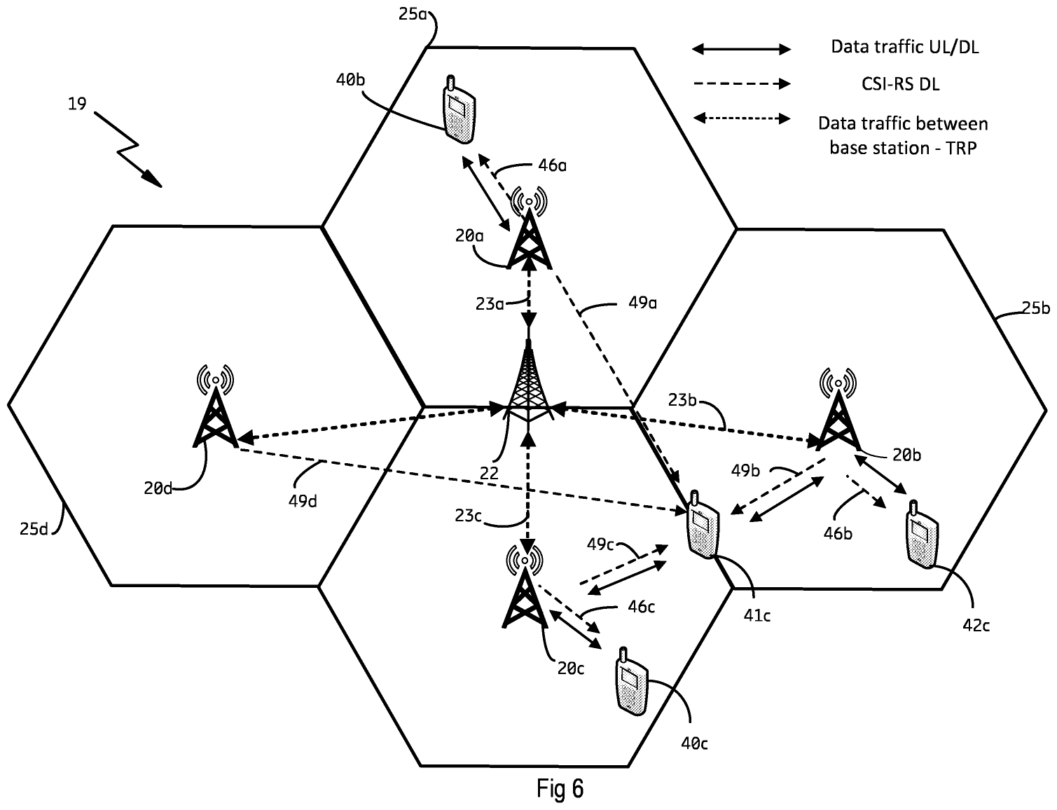

FIG. 1 illustrates a method 700 performed by a network node 150 (see FIG. 2) which comprises multiple transmission reception points. Embodiments of the method 700 are also present in the flowcharts of FIGS. 2, 4 and 5 and further detail may be found there and in FIGS. 3 and 6 and in the corresponding descriptive text of the figures. The method 700 begin with the network node 150 sending, 102, at least a first and a second set of CSI-RSs, wherein the first set is sent as a joint transmission from a group of TRPs and the second set is TRP-specific among said group.

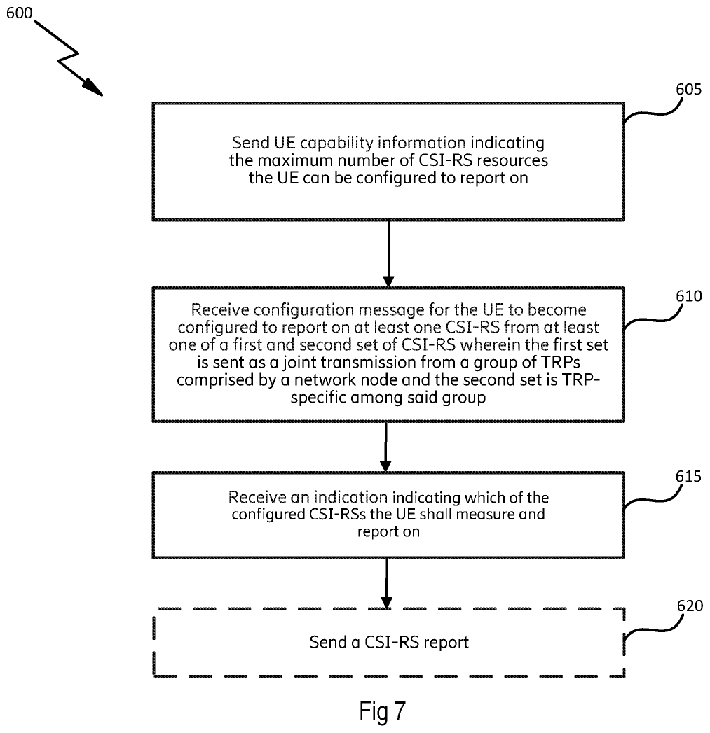

The network node 150 receives, 103, a UE capability information indicating the maximum number of CSI-RS resources a UE 100 can be configured to report on. In an embodiment, the UE capability information is sent by a UE, corresponding to step 605 described in conjunction with FIG. 7.

After receiving 103 the UE capability information the network node 150 sends (see 106, 108) a configuration message to the UE 100 for the UE to become configured to report on at least one CSI-RS from at least one of the first and second set based on the UE capability information. In an embodiment, the configuration message is received by the UE, corresponding to step 610 described in conjunction with FIG. 7.

The network node 150 sends (see 107, 110) an indication to the UE 100 indicating which of the configured at least one CSI-RS the UE shall measure and report on. In an embodiment, the indication is based on a traffic scenario, the traffic scenario corresponding to at least one of a data traffic of the UE and whether CoMP is desired. In an embodiment, the UE receives the indication, corresponding to step 615 described in conjunction with FIG. 7.

After sending (107, 110) the indication the network node 150 optionally receives (see 115, 120) a CSI-RS report. In an embodiment, the UE sends the CSI-RS report, corresponding to step 620 described in conjunction with FIG. 7.

FIG. 2 illustrates a flowchart according to an embodiment of the invention, wherein configuration of CSI-RS reporting is based on the maximum number of CSI-RS resources a UE 100 can be configured to report on. The process starts with an optional cell startup 101, which generally describes a scenario where a UE registers with a network node 150. Each TRP 20 of the multi-TRP cell 19 sends, 102, two CSI-RSs, one of which is a joint transmission of CSI-RS common for all TRPs in the multi-TRP cell, CSI-RS 0, and the other being a CSI-RS unique to each TRP in the multi-TRP cell, CSI-RS i. In an embodiment, a TRP sends sets of each of the two CSI-RSs, wherein, for example, multiple joint transmissions are enabled for different subsets of TRPs within the multi-TRP cell.

A UE capability information is received, 103, by the network node 150. In an embodiment, the UE capability information is sent from the UE 100 to the network node and/or sent by another network node, not necessarily comprised by the same multi-TRP cell. In an embodiment the UE capability information is requested by the network node 150 through sending UECapabilityEnquiry and receiving UECapabilitylnformation from a UE.

After receiving 103 the UE capability information, the maximum number of CSI-RS resources the UE 100 can be configured to report on is indicated, 104, by the UE capability information. According to an embodiment of step 104, the maximum number of CSI-RS resources the UE can be configured to report on is inferred and/or determined from the received 103 UE capability information. The UE capability information may here comprise parameters specified in Third Generation Partnership Project (3GPP) TS38.306, e.g., V15.13.0 and V16.4.0, with reference to UE Capability Parameters in clause 4.2 thereof. As an example, the maximum number of CSI-RS resources the UE 100 can be configured to report on, for aperiodic CSI-RS configuration, is indicated by the minimum value of the parameters maxConfigNumberNZP-CSI-RS-PerCC and maxNumberAperiodicCSI-PerBWP-ForCSI-Report], wherein maxConfigNumberNZP-CSI-RS-PerCC and maxNumberAperiodicCSI-PerBWP-ForCSI-Report are received in an RRC message UECapabilitylnformation. The parameter maxConfigNumberNZP-CSI-RS-PerCC specifies the maximum number of CSI-RS resources that can be configured for a UE within a component carrier. The parameter maxNumberAperiodicCSI-PerBWP-ForCSI-Report specifies the maximum number of a periodic CSI-RS report settings that a UE supports and one such setting is required per CSI-RS resource.

As can be appreciated by the person skilled in the art, parameters corresponding to semi-persistent configured CSI-RS resources may be used for determining the maximum number of supported CSI-RS resources when semi-persistent CSI-RS resources are configured. Whether or not semi-persistent resources are supported by the UE 100 is indicated by the capabilities sp-CSI-RS and sp-CSI-IM, also present in the message UECapabilitylnformation. Using periodic resources is inefficient since the UE must be able to decode CSI-RS resources from TRPs for which it has no traffic ongoing with. Furthermore, there are other capabilities that will restrict how many simultaneous periodic CSI-RS resources the UE 100 can decode, such as maxNumberSimultaneousNZP-CSI-RS-ActBWP-AIICC and totalNumberPortsSimultaneousNZP-CSI-RS-PerCC.

The maximum number of CSI-RS resources the UE 100 can be configured to report on is used to determine, 105, if the number of supported CSI-RS resources is equal to or above a first threshold value. As used herein, the number of supported CSI-RS resources by a UE is equivalent to the maximum number of CSI-RS the UE can be configured to report on. If the number of supported CSI-RS resources is equal to or above said first threshold, the UE 100 is of high capability 140 and low capability 130 if below the first threshold. The first threshold value may be any value larger than one, e.g. four. As can be appreciated by the person skilled in the art, the first threshold may be defined in other ways than, equal to or above, and below the first threshold. For example, equal to or below, and above the first threshold. In yet another example, the first threshold may correspond to a list of values of the maximum number of CSI-RS the UE 100 can be configured to report on, wherein the UE is defined as high or low capability based on inclusion or exclusion from said list.

According to an embodiment the UE 100 is configured with up to the maximum number of CSI-RS resources it supports. In an embodiment, a configuration message for configuring the UE with CSI-RS resources is RRCReconfiguration or RRCConnectionReconfiguration in 5G and 4G correspondingly.

The configuration message is sent, 106, to the UE. A low capability UE 130 which has received the configuration message is configured, 126, with at least the jointly transmitted common CSI-RS, CSI-RS 0, and may also be configured with other CSI-RSs such as a TRP-specific CSI-RS, CSI-RS i, if the UE's capability allows. The configuration message is sent, 108, to the UE. A high capability UE 140 which has received the configuration message is configured, 128, with at least a group of TRP-specific CSI-RSs and may also be configured with other CSI-RSs, including the jointly transmitted common CSI-RS, CSI-RS 0.

A UE 130 with low capability receives an indication to measure and report on the jointly transmitted common CSI-RS, CSI-RS 0, after being configured 126 with said joint transmission. The network node 150 sends, 107, said indication to the UE. After receiving said indication, the UE optionally measures and reports on the joint transmission of CSI-RS, which is then optionally received, 115, by the network node.

A UE 140 with high capability receives an indication to measure and report on a TRP-specific CSI-RS, CSI-RSi, of a chosen TRP after being configured 128 with said TRP-specific CSI-RS. The network node 150 sends, 110, said indication to the UE. According to an embodiment, the TRP 20 which enables best performance is chosen by the network node, wherein best performance may correspond to the highest received signal power and/or signal quality and may be the result of being the closest TRP in distance to the UE. After receiving said indication, the UE measures and reports on said TRP-specific CSI-RS, which is then optionally received, 120, by the network node. An optional step of the network node is to determine, 109, the best TRP, and may for example be based on UL/DL signal strength/quality or other factors. This determining 109 of the best TRP is in FIG. 2 shown as being performed after the configuring in step 108, but could alternatively be performed before configuring the UE, step 108, if such information is available at the network node. In such an embodiment, the group of TRP-specific CSI-RSs configured for the UE correspond to the TRPs offering best performance.

A network node 150 may send, 110, after the optional step of the determining 109, an indication to the UE 140 indicating the UE to switch the CSI-RS it measures and reports on, from a first CSI-RS to a second CSI-RS, as is illustrated by the arrows between steps 120, 109 and 108. As an example, switching from a first to a second CSI-RS may occur when the UE moves closer to another TRP, e.g. radio coverage by the another TRP is better than the current TRP. If the UE is already configured with the second TRP-specific CSI-RS, from step 108, it may use MAC signaling to switch, i.e., the network node sends 110 an indication. Otherwise, the UE 140 first needs to be re-configured, return to step 108, with at least the second CSI-RS through RRC signaling.

In an embodiment, the sending (107, 110) of the indication is a trigger for the UE to change CSI-RS. In another embodiment, the indication is sent in a SP CSI-RS/CSI-IM Resource Set Activation/Deactivation MAC CE message. In yet another embodiment, the indication is explicitly and/or implicitly comprised in the configuration message or by the configuration message itself. For example, an implicit indication is if a UE 100 is only configured with one CSI-RS resource, then it is sufficient for the UE to only receive the configuration message for the UE to be indicated to measure and report on said CSI-RS resource.

In an embodiment, the first threshold for defining high and low capability of a UE is based on at least one of: a number of TRPs in a multi-TRP cell, a number of component carriers assigned to the UE, a carrier aggregation requirement, a minimal re-use ratio of CSI-RSs in a multi-TRP cell and on a reference UE model, e.g. the UE model with the highest maximum number of supported CSI-RS resources available in a market.

FIG. 3 illustrates a multi-TRP cell 19 wherein each TRP coverage area 25 comprises a TRP 20. The embodiments described below with reference to FIG. 3 are based on the flowchart seen in FIG. 2. The network node 150 communicates with the TRPs 20 along connections 23, which may be fixed or wireless. User equipment 130a and 130b have a low capability in terms of supporting CSI-RS resources and UEs 140a and 140b have a high capability in supporting CSI-RS resources. The CSI-RSs are depicted by the one-way dashed arrows in downlink direction. Uplink and downlink data traffic are shown by the solid double arrows and the communication between network node and TRPs is shown by the dashed double arrows.

The high capability UE 140a is configured (step 128, FIG. 2) with at least the TRP-specific CSI-RSs of TRPs 20d and 20c, CSI-RS 27a and 27b correspondingly. In an embodiment, the UE 140a initially measures and reports (step 120. FIG. 2) on the CSI-RS 27a from the TRP 20d and is served by the TRP 20d. The UE 140a then moves to position 140b and the network node 150 determines (step 109, FIG. 2) that the TRP-specific CSI-RS 27b from the TRP 20c offers better performance than the CSI-RS 27a. An indication (step 110, FIG. 2) is sent from the network node to a TRP 20, e.g., the TRP 20d, and then sent to the UE 140b, indicating the UE 140b to report on the CSI-RS 27b. After having moved, the UE 140b is served by the TRP 20c and the CSI-RS 27a towards the UE 140b will not interfere with the CSI-RS 27b sent by the TRP 20c, since the CSI-RS 27a is scheduled on another CSI-RS resource. In case the UE 140b was not configured with the CSI-RS 27b of TRP 20c, the UE 140b would need to be re-configured (step 128, FIG. 2) before being able to report on the CSI-RS 27b.

The low capability UE 130a is configured (step 126, FIG. 2) with at least the jointly transmitted common CSI-RS resource 28. In an embodiment, the UE 130a is measuring and reporting (step 115, FIG. 2) on the CSI-RSs 28a-d but is only exchanging user plane data with the TRP 20a. In another embodiment, data is sent and/or received to and from all TRPs, effectively increasing the signaling power and likelihood of successful transmissions.

In another embodiment, the low capability UE 130a moves to a new location, now depicted UE 130b and measuring and reporting on (step 115, FIG. 2) the CSI-RS 29, which may be the same joint transmission as CSI-RS 28. In such a scenario, there is no need for the UE 130b to re-configure its CSI-RS resources nor a need to be indicated to switch CSI-RS resource, since it is reporting on said same joint transmission of CSI-RS.

Said methods for TRP selection and reselection in FIG. 3 may be embodied in several ways. In an embodiment, the network node communicates directly with UEs 130 and 140, instead of and/or in addition to, relaying information through the TRPs 20. The TRPs 20 can be spread out in a cell coverage area of the multi-TRP cell, as shown in FIG. 3. The TRPs can also be co-sited, e.g. located centrally by the network node 150, wherein the TRP cell coverage areas correspond to sectors around the network node, e.g. the TRPs comprise transceivers directed towards certain sectors of the multi-TRP cell.

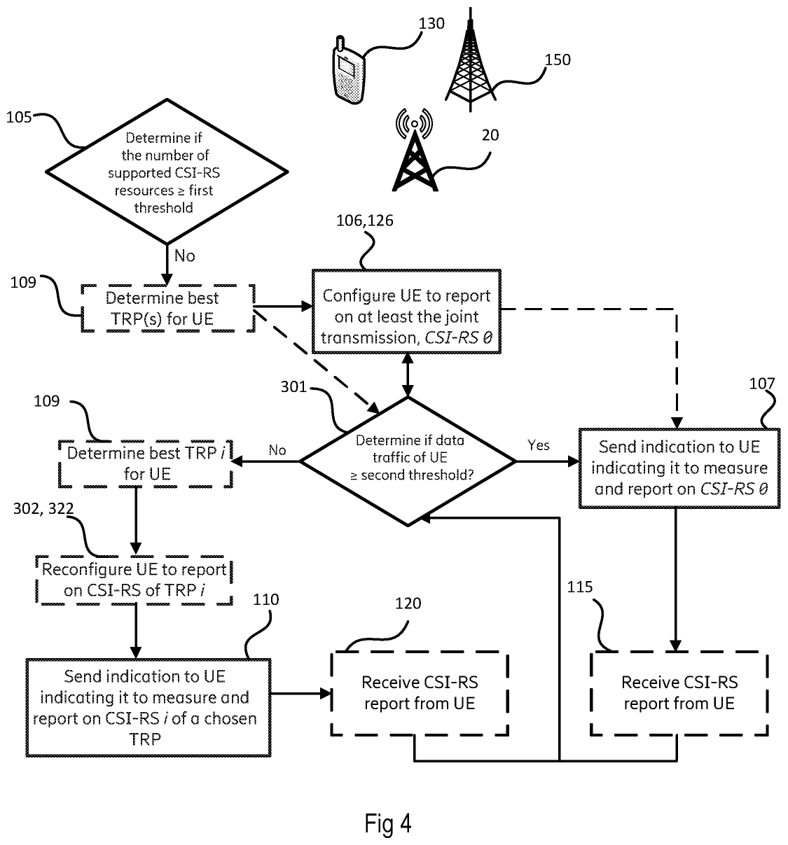

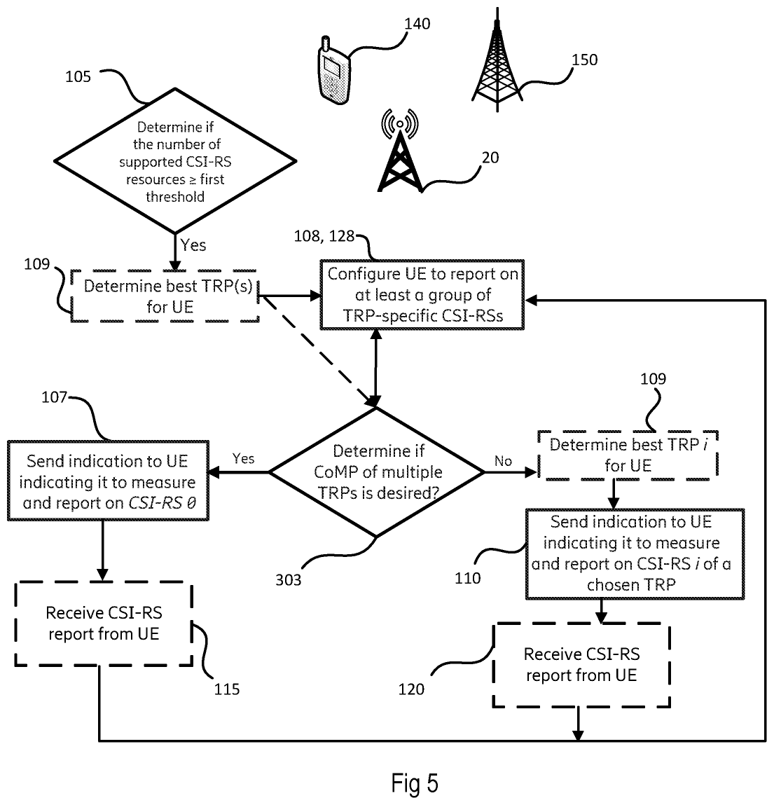

FIG. 4 illustrates a flowchart according an embodiment of the invention, wherein CSI-RS configuration and reporting are based on the number of supported CSI-RS resources of a UE 100 and a traffic scenario. The flowchart of FIG. 4 builds on the flowchart of FIG. 2 with the addition of some steps being based on a traffic scenario, thus reference is also made to the descriptive text above in conjunction with FIG. 2 for further information. Only low capability UEs 130 are covered in this flowchart, while a corresponding flowchart for high capability UEs 140 is shown in FIG. 5.

A configuration message is sent, 106, to the UE. A low capability UE 130 which has received the configuration message is configured, 126, with at least the jointly transmitted common CSI-RS, CSI-RS 0. The network node 150 determines, 301, whether a data traffic of the low capability UE 130 is, equal to or above, or below a second threshold. In an embodiment, the data traffic of the UE is known before the configuring, 126, of the CSI-RS resource/s. Hence, following the flowchart, step 301 may be performed after step 105 or step 109, and the configuring, 126, of what CSI-RS resource/s to configure may be based on data traffic. For example, a UE 130 with data traffic above the second threshold is configured with the jointly transmitted common CSI-RS, CSI-RS 0. In an embodiment, the network node proceeds to step 107 from step 126 instead of proceeding to step 301. This may be the case when information about a data traffic of the UE is not available and a CSI-RS report is generated to assist with obtaining the data traffic information, wherein the data traffic information may be comprised in user plane and/or control plane data.

In an embodiment, the data traffic of a UE 100 is associated with at least one of a QoS parameter, a QoS identifier (5QI) and a mobility indication for the UE, e.g. an indication whether the UE is regarded as stationary or not. In an embodiment, the second threshold corresponds to a value, the value being compared with a 5QI value and/or a QoS parameter. In an embodiment, the second threshold corresponds to a threshold list of QoS parameters and/or 5QI values, the threshold list comprising at least one value, wherein a traffic of the UE is equal to or above said second threshold if the 5QI value and/or the QoS parameter associated with the traffic of the UE is included in said list. In another embodiment, a data traffic of the UE is equal to or above said second threshold if the 5QI value or the QoS parameter associated with the UE is excluded from said list. In an embodiment, the data traffic is associated with a movement of the UE, e.g. a speed of the UE and/or whether the UE is stationary. For example, if it has been detected that a UE has been stationary for a certain amount of time and/or if it is known that a UE will be stationary for a certain amount of time, it is determined that the UE has a data traffic below said second threshold. In particular, being stationary for longer stretches of time is common for certain IoT devices, e.g. electricity meters. In an embodiment, the UE detects that it is stationary and indicates that to the network node. The time limit for being deemed as stationary can be chosen to any number, e.g. one hour. For example, a UE streaming a video or performing mission-critical communication can measure and report on a joint transmission of CSI-RS, whilst a UE that is stationary and/or is performing communication with low data rate requirements can report on a TRP-specific CSI-RS.

A low capability UE 130 with a data traffic equal to or above said second threshold receives an indication to measure and report on the jointly transmitted common CSI-RS, CSI-RS 0, after being configured 126 with said joint transmission. The network node 150 sends, 107, said indication to the UE. After receiving said indication, the UE optionally measures and reports on the joint transmission of CSI-RS, which is then optionally received, 115, by the network node.

A configuration message is sent, 302, to the UE. A low capability UE 130 with a data traffic below said second threshold, which has received the configuration message, is re-configured, 322, through RRC signaling to report on at least a TRP-specific CSI-RS, CSI-RSi, of a chosen TRP. The UE 130 then receives an indication to measure and report on said CSI-RS, sent, 110, from the network node 150 and optionally sends a CSI-RS report, optionally received, 120, by the network node. In an embodiment, the TRP-specific CSI-RS of a determined 109 TRP which enables best performance is chosen. If the UE was already configured with said chosen TRP-specific CSI-RS, CSI-RS i, no re-configuration is necessary and reception of an indication sent 110 from the network node indicating the UE 130 to switch CSI-RS resource through MAC signaling, is sufficient.

FIG. 5 illustrates a flowchart according an embodiment of the invention, wherein CSI-RS configuration and reporting are based on the number of supported CSI-RS resources of a UE 100 and a traffic scenario. The flowchart of FIG. 5 builds on the flowchart of FIG. 2 with the addition of some steps being based on a traffic scenario, thus reference is also made to the text above in conjunction with FIG. 2 for further information. Only high capability UEs, 140, are related to this flowchart.

A configuration message is sent, 108, to the UE. A high capability UE 140 which has received the configuration message is configured, 128, with at least a group of TRP-specific CSI-RSs. In an embodiment, the TRP-specific CSI-RSs correspond to the TRPs 20 that offer a best signal quality/power among the TRPs in the multi-TRP cell and may be the TRPs closest in geographical distance to the UE.

The network node 150 determines, 303, whether coordinated multipoint signaling with multiple TRPs is desired for the UE. In an embodiment, the desirability of CoMP is known before the configuring 128 of the CSI-RS resources. Hence, following the flowchart, step 303 may be performed after step 105 or step 109, and the configuring 128 of what CSI-RS resources to configure for the UE may be based on whether CoMP is desired or not. In an embodiment, CoMP is desired when a difference between a received UL signal power and/or quality from a UE to two TRPs 20 is below some threshold. For example, this may be the case when a UE is located at approximately the same distance from the two TRPs.

If CoMP is desired, the network node 150 sends, 107, an indication to the UE 140 indicating the UE to measure and report on the jointly transmitted common CSI-RS, CSI-RS 0. The UE 140 optionally measures and reports on said CSI-RS, which is then optionally received, 115, by the network node 150. Depending on whether the UE was already configured with the CSI-RS 0, the UE may first need to be re-configured 108 to report on CSI-RS 0.

If CoMP is not desired, the network node 150 sends, 110, an indication to the UE 140 indicating the UE to report on a chosen TRP-specific CSI-RS, CSI-RSi. The UE 140 optionally measures and reports on said CSI-RS, optionally received, 120, by the network node 150. In an embodiment, the TRP-specific CSI-RS of a determined, 109, TRP that enables best performance is chosen.

FIG. 6 illustrates a multi-TRP cell 19 similar to the one in FIG. 3. A difference being that the embodiments in FIG. 6 are based on the flowcharts of FIG. 4 and FIG. 5, thus configuration and reporting of CSI-RSs are further based on a traffic scenario. Only the traffic scenario will be disclosed in more detail here, for further information and examples, reference is made to FIG. 3 and the text in conjunction thereto.

The UE 40c has a high capability and is in an example configured (according to step 128, FIG. 5) with at least a TRP-specific CSI-RS, CSI-RS 46c, of the TRP 20c and a jointly transmitted common CSI-RS, CSI-RS 49. According to an embodiment, the UE 40c measures and reports on the CSI-RS 46c and is served by the TRP 20c, which receives (step 120, FIG. 5) the report. The UE 40c then moves to position 41c and the network node 150 determines (step 303, FIG. 5) that CoMP is beneficial. An indication is sent (step 107, FIG. 5) from the network node to the TRP 20c and then sent to the UE 41c, indicating the UE 41c to measure report on the jointly transmitted common CSI-RS, CSI-RS 49. According to an embodiment, the UE 41c moves further to position 42c and the network node determines (step 303, FIG. 5) that CoMP signaling is not desired anymore. An indication is sent (step 110, FIG. 5) from the network node to the TRP 26c and/or the TRP 20b and then sent to the UE 42c, indicating the UE 42c to measure and report on the TRP-specific CSI-RS 46b of TRP 20b. In case the UE 42c was not configured with CSI-RS 46b of TRP 20b, the UE 42c would need to be reconfigured (step 128, FIG. 5) before being able to measure and report on CSI-RS 46b.

According to another embodiment, the UE 41c has low capability and a data traffic of the UE 41c is equal to or above the second threshold, e.g., at least one QoS parameter equal to or above a second threshold value. Following the steps in the flowchart of FIG. 4, the UE 41c is configured (step 126, FIG. 4) to measure and report on the joint transmission of CSI-RS, CSI-RS 49. Since a data traffic of the UE 41c is equal to or above the second threshold, the UE 41c receives an indication, sent (step 107, FIG. 4) by the network node 150, and measures and reports on said joint transmission of CSI-RS, received (step 115, FIG. 4) by the network node 150. According to an embodiment, said data traffic of the UE 41c may change and fall below said second threshold, now represented as the UE 40b.In an example, the network node 150 determines (step 301, FIG. 4) that said data traffic is below said second threshold and determines (see step 109, FIG. 4), reconfigures (see step 322, FIG. 4) and indicates (see step 110, FIG. 4) the UE 40b to measure and report (see step 120, FIG. 4) on the best TRP-specific CSI-RS, in this example corresponding to the TRP-specific CSI-RS, CSI-RS 46a, of the TRP 26a which also serves the UE 40b.

FIG. 7 illustrates a method 600 performed by a UE 100. Embodiments of the method 600 and details thereof are found in the corresponding method for a network node 150, as present in the flowcharts of FIGS. 2, 4 and 5 as well as in FIGS. 3 and 6 and in the corresponding descriptive text of the figures. The method 600 begin with the UE 100 sending, 605, a UE capability information indicating the maximum number of CSI-RS resources the UE can be configured to report on. In an embodiment, the UE capability information is received by a network node 150, corresponding to step 103 described in conjunction with FIG. 1.

The UE 100 receives, 610, a configuration message for the UE to become configured to report on at least one CSI-RS from at least one of a first and second set of CSI-RS based on the UE capability information, wherein the first set is sent as a joint transmission from a group of TRPs and the second set is TRP-specific among said group. In an embodiment, the configuration message is sent by a network node, 150, corresponding to step 106 or step 108 described in conjunction with FIG. 1.

The UE 100 receives, 615, an indication indicating which of the configured at least one CSI-RS the UE shall measure and report on. In an embodiment, the indication is sent by a network node, 150, corresponding to step 107 or step 110 described in conjunction with FIG. 1.

The UE 100 optionally sends, 620, a CSI-RS report which may be received by a network node 150 e.g. the serving TRP of the UE, the receiving demonstrated by step 115 or step 120 described in conjunction with FIG. 1.

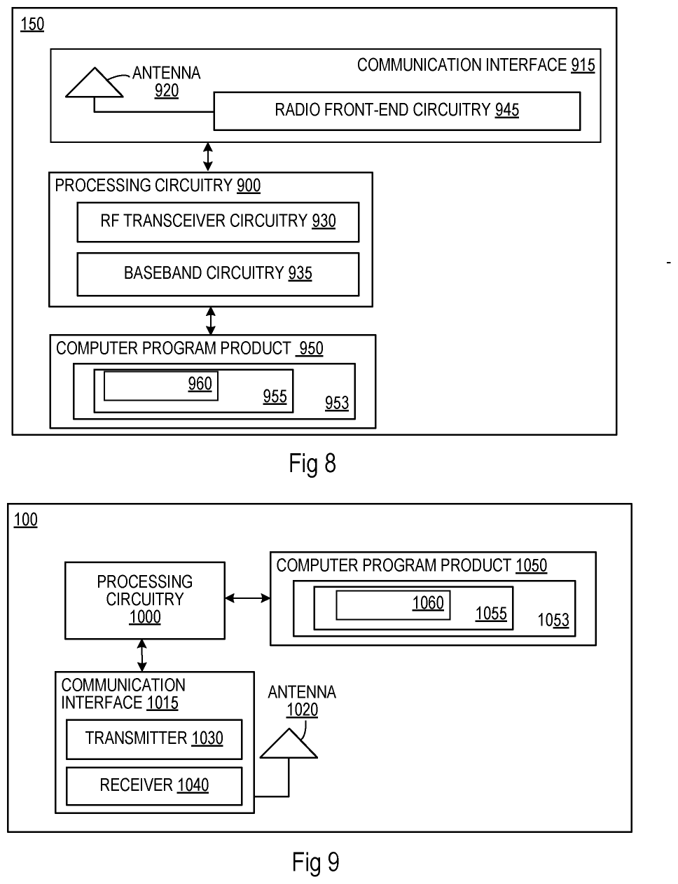

FIG. 8 illustrates a network node 150 in accordance with some embodiments. As used herein, a network node refers to equipment capable, configured, arranged and/or operable to communicate directly or indirectly with a UE 100 and in many implementations also with other network nodes or equipment in a wireless communication system, wherein examples of network nodes include, but are not limited to access points (e.g. radio access points), BSs (e.g. radio base stations, Node Bs, evolved Node Bs (eNBs) and NR Node Bs (gNBs)).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node 150 may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes 150 include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs).

The network node 150 of FIG. 8 includes processing circuitry 900, a computer program product 950 and a communication interface 915 comprising an antenna 920. The network node may be composed of multiple physically separate components (e.g., a NodeB component and a RNC component, or a BTS component and a BSC component, etc.), which may each have their own respective components. In certain scenarios in which the network node 150 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node 150 may be configured to support multiple radio access technologies (RATs). In such embodiments, some components may be duplicated (e.g., separate computer program product 950 for different RATs) and some components may be reused (e.g., a same antenna 920 may be shared by different RATs).

The computer program product 950 may include one or more non-volatile storage medium and/or one or more volatile storage medium. The computer program product 950 includes a memory 953 having a computer readable storage medium 955 storing a computer program 960 comprising computer readable instructions. In some embodiments, the computer readable instructions of computer program 960 are configured such that when executed by processing circuitry 900, the computer readable instructions cause the network node 150 to perform steps according to any of the embodiments described herein (e.g., steps described herein with reference to FIGS. 1, 2, 4 and 5 and the text relating thereto). In other embodiments, the network node 150 is configured to perform steps described herein without the need for code. That is, for example, processing circuitry 900 consists merely of one or more ASICs. Hence, the features of the embodiments described herein may be implemented in hardware and/or software.

The computer readable storage medium 955 may store any suitable instructions, data, or information, including software, an application including one or more of logic, rules, code, tables, and/or other instructions/computer program code capable of being executed by the processing circuitry 900 and utilized by the network node 150. The computer readable storage medium 955 may further be used to store any calculations mode by the processing circuitry 900 and/or any data received via the communication interface 915, such as data indicative of: a maximum number of configurable CSI-RS resources for a UE 100, configured CSI-RS resources for the UE 100, a data traffic of the UE 100, thresholds described in the disclosure and information for deciding said thresholds, whether CoMP is desired for the UE 100 and the indicated CSI-RS resource forth UE 100 to measure and report on. In some embodiments, the processing circuitry 900 and computer readable storage medium 955 are integrated. In some embodiments, said calculations and/or data are instead stored in another network node.

The communication interface 915 is used in wired and/or wireless communication for signaling and/or transfer of user data between the network node 150 and a UE 100 and/or for communication with another network node, and/or for communication with a TRP 20 and/or for communication with entities of a core network. The communication interface 915 may include an interface adapted for direct communication with another network node and/or a TRP, e.g. a Bluetooth interface. The communication interface 915 of FIG. 8 includes radio front-end circuitry 945 that may be coupled to, or in certain embodiments part of, the antenna 920. The radio front-end circuitry 945 may receive digital data that is to be sent out to other communication network entities such as network nodes 150, UEs 100 and TRPs 20, via a wireless connection. Similarly, when receiving data, the antenna 920 may collect radio signals, which are then converted into digital data by the radio front-end circuitry 945. The radio front-end circuitry 945 of FIG. 8 is connected to the antenna 920 and to processing circuitry 900. The radio front-end circuitry 945 may be configured to condition signals communicated between antenna 920 and processing circuitry 900.

In some alternative embodiments, the network node, 150, does not include separate radio front-end circuitry 945, instead, the processing circuitry 900 includes radio front-end circuitry and is connected to the antenna 920. In some embodiments, all or some of the radio-frequency, RF, transceiver circuitry 930 and/or base band circuitry 935 is part of the communication interface 915.

The antenna 920 may include one or more antennas, or antenna arrays, configured to send and/or receive wireless signals.

Embodiments of the network node 150 may include additional components beyond those shown in FIG. 8 for providing certain aspects of the network node's functionality, including any of the functionality described herein and/or any functionality necessary to support the subject matter described herein. For example, in certain embodiments, communication interface 915 comprises port(s)/terminal(s) for sending and receiving data over a wired connection.

FIG. 9 shows a UE 100 in accordance with some embodiments. As used herein, a UE refers to a device capable, configured, arranged and/or operable to communicate wirelessly with network nodes and/or other UEs. Examples of a UE include, but are not limited to, a smart phone, mobile phone, cell phone, voice over IP (VoIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc. Other examples include any UE identified by the 3rd Generation Partnership Project (3GPP), including a narrow band internet of things (NB-IoT) UE, a machine type communication (MTC) UE, and/or an enhanced MTC (eMTC) UE.

A UE 100, when in the form of an Internet of Things (IoT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE 100 shown in FIG. 9.

A UE 100 may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE 100 includes processing circuitry 1000, a computer program product 1050 and a communication interface 1015. Certain UEs may utilize all or a subset of the components shown in FIG. 9. The level of integration between the components may vary from one UE to another UE. Further, certain UEs may contain multiple instances of a component, such as multiple processors, memories, transceivers, transmitters, receivers, etc.

The computer program product 1050 may include one or more non-volatile storage medium and/or one or more volatile storage medium. The computer program product 1050 includes a memory 1053 having a computer readable storage medium 1055 storing a computer program 1060 comprising computer readable instructions. In some embodiments, the computer readable instructions of computer program 1060 are configured such that when executed by processing circuitry 1000, the computer readable instructions cause the UE 100 to perform steps according to any of the embodiments described herein (e.g., steps described herein with reference to FIGS. 2, 4, 5 and 7 and the text relating thereto). In other embodiments, the UE 100 is configured to perform steps described herein without the need for code. That is, for example, processing circuitry 1000 consists merely of one or more ASICs. Hence, the features of the embodiments described herein may be implemented in hardware and/or software.

The computer readable storage medium 1055 may store any suitable instructions, data, or information, including software, an application including one or more of logic, rules, code, tables, and/or other instructions/computer program code capable of being executed by the processing circuitry 1000 and utilized by the UE 100. The computer readable storage medium 1055 may further be used to store any calculations made by the processing circuitry 1000 and/or any data received via the communication interface 1015, such as data indicative of: a maximum number of configurable CSI-RS resources for the UE 100, configured CSI-RS resources for the UE 100, a data traffic of the UE 100, thresholds described in the disclosure and information for deciding said thresholds, whether CoMP is desired for the UE 100 and the indicated CSI-RS resource for the UE 100 to measure and report on. In some embodiments, the processing circuitry 1000 and computer readable storage medium 1055 are integrated. In some embodiments, said calculations and/or data are instead stored in another network node.

The processing circuitry 1000 may be configured to communicate with an access network or other network, using the communication interface 1015. The communication interface 1015 may comprise one or more communication subsystems and may include or be communicatively coupled to an antenna 1020. The communication interface 1015 may include one or more transceivers used to communicate, such as by communicating with one or more remote transceivers of another device capable of wireless communication (e.g., another UE or a network node in an access network). Each transceiver may include a transmitter 1030 and/or a receiver 1040 appropriate to provide network communications (e.g., optical, electrical, frequency allocations, and so forth). Moreover, the transmitter 1030 and receiver 1040 may be coupled to one or more antennas (e.g., antenna 1020) and may share circuit components, software or firmware, or alternatively be implemented separately.

In the illustrated embodiment, communication functions of the communication interface 1015 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

Although the computing devices described herein (e.g., UE and network node) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

1-84. (canceled)

85. A method, performed by network node comprising transmission reception points (TRPs) in a cellular communication network, for configuring Channel State Information Reference Signal (CSI-RS) reporting for a user equipment (UE), comprising:
sending at least a first set and a second set of CSI-RSs, wherein the first set is sent as a joint transmission from a group of TRPs and the second set is TRP-specific among said group;
receiving a UE capability information, wherein the UE capability information indicates a maximum number of CSI-RS resources the UE can be configured to report on;
sending a configuration message to the UE for the UE to become configured to report on at least one CSI-RS from at least one of the first and second set based on the UE capability information;
sending an indication to the UE indicating which of the configured at least one CSI-RS the UE shall measure and report on.

86. A method performed by a user equipment (UE) for becoming configured for Channel State Information Reference Signal (CSI-RS) reporting, comprising:
sending a UE capability information to a network node, wherein the UE capability information indicates a maximum number of CSI-RS resources the UE can be configured to report on;
receiving a configuration message for the UE to become configured to report on at least one CSI-RS from at least one of a first and second set of CSI-RSs based on the UE capability information, wherein the first set is sent as a joint transmission from a group of transmission reception points (TRPs) comprised by the network node and the second set is TRP-specific among said group; and
receiving an indication indicating which of the configured at least one CSI-RS the UE shall measure and report on.

87. A network node comprising transmission reception points (TRPs) in a cellular communication network for configuring Channel State Information Reference Signal (CSI-RS) reporting for a user equipment (UE), comprising:
processing circuitry; and
memory comprising computer readable instructions executable by the processing circuitry, whereby the network node is configured to:
send at least a first and a second set of CSI-RSs, wherein the first set is sent as a joint transmission from a group of TRPs and the second set is TRP-specific among said group;
receive a UE capability information, wherein the UE capability information indicates a maximum number of CSI-RS resources a UE can be configured to report on;
send a configuration message to the UE for the UE to become configured to report on at least one CSI-RS from at least one of the first and second set based on the UE capability information; and
send an indication to the UE indicating which of the configured at least one CSI-RS the UE shall measure and report on.

88. The network node of claim 87, wherein the UE is indicated by the indication to measure and report on a CSI-RS from the first set if the maximum number of CSI-RS resources the UE can be configured to report on is below a first threshold value.

89. The network node of claim 87, wherein the UE is indicated by the indication to measure and report on a chosen TRP's CSI-RS from the second set if the maximum number of CSI-RS resources the UE can be configured to report on is equal to or above a first threshold value.

90. The network node of claim 87, wherein the indication is based on a traffic scenario, and wherein the traffic scenario corresponds to at least one of:
a data traffic of the UE; and
whether coordinated multipoint, CoMP, signaling is desired.

91. The network node of claim 87, wherein the indication indicating which of the configured at least one CSI-RS the UE shall measure and report on is a trigger.

92. The network node of claim 87, wherein the indication indicating which of the configured at least one CSI-RS the UE shall measure and report on is comprised in at least one of SP CSI-RS/CSI-IM Resource Set Activation/Deactivation MAC CE and downlink control information.

93. A user equipment (UE), the UE comprising:
processing circuitry; and
memory comprising computer readable instructions executable by the processing circuitry, wherein the UE is configured to:
send a UE capability information to a network node, wherein the UE capability information indicates a maximum number of CSI-RS resources the UE can be configured to report on;
receive a configuration message for the UE to become configured to report on at least one CSI-RS from at least one of a first and second set of CSI-RSs based on the UE capability information, wherein the first set is sent as a joint transmission from a group of TRPs comprised by the network node and the second set is TRP-specific among said group; and
receive an indication indicating which of the configured at least one CSI-RS the UE shall measure and report on.

94. The UE of claim 93, wherein the UE is enabled to become configured by the configuration message to report on at least a CSI-RS from the first set if the maximum number of CSI-RS resources the UE can be configured to report on is below a first threshold value.

95. The UE of claim 93, wherein the UE is enabled to become configured by the configuration message to report on at least a group of CSI-RSs from the second set if the maximum number of CSI-RS resources the UE can be configured to report on is equal to or above a first threshold value.

96. The UE of claim 93, wherein the UE is indicated by the indication to report on a CSI-RS from the first set if the maximum number of CSI-RS resources the UE can be configured to report on is below a first threshold value.

97. The UE of claim 93, wherein the UE is indicated by the indication to report on a chosen TRP's CSI-RS from the second set if the maximum number of CSI-RS resources the UE can be configured to report on is equal to or above a first threshold value.

98. The UE of claim 93, wherein the indication is based on a traffic scenario, and wherein the traffic scenario corresponds to at least one of:
a data traffic of the UE; and
whether coordinated multipoint, CoMP, signaling is desired.

99. The UE of claim 93, wherein the indication is comprised in the configuration message or is the configuration message.

100. The UE of claim 93, wherein the UE capability information is comprised in UECapabilitylnformation.

101. The UE of claim 93, wherein the maximum number of CSI-RS resources the UE can be configured to report on is indicated by the minimum value of the parameters:
maxConfigNumberNZP-CSI-RS-PerCC, and
maxNumberAperiodicCSI-PerBWP-ForCSI-Report, and wherein
maxConfigNumberNZP-CSI-RS-PerCC and maxNumberAperiodicCSI-PerBWP-ForCSI-Report are comprised in the UE capability information.

102. The UE of claim 93, wherein the configuration message is comprised in at least one of RRCReconfiguration or RRCConnectionReconfiguration in 5G and 4G correspondingly.

103. The UE of claim 93, wherein the indication indicating which of the configured at least one CSI-RS the UE shall measure and report on is a trigger.

104. The UE of claim 93, wherein the indication indicating which of the configured at least one CSI-RS the UE shall measure and report on is comprised in at least one of SP CSI-RS/CSI-IM Resource Set Activation/Deactivation MAC CE and downlink control information.
